(19) United States
(12) Patent Application Publication
(10) Pub. No.: US 2012/0141276 A1
(43) Pub. Date: Jun. 7, 2012

(54) FREQUENCY-DEPENDENT DAMPER AND ROTARY WING SYSTEM

(76) Inventors: Zachary Ryan Fuhrer, Erie, PA (US); Mark R. Jolly, Raleigh, NC (US)

(21) Appl. No.: 13/308,793

(22) Filed: Dec. 1, 2011

Related U.S. Application Data
(63) Continuation of application No. 61/419,794, filed on Dec. 3, 2010.

(51) Int. Cl. B64C 27/51; F16F 13/26; B23P 13/00; F01D 5/10; B23P 17/00; F16F 13/00; F16F 13/06

(52) U.S. Cl. 416/140; 267/140.13; 267/140.11; 29/890.09; 29/896.93

(57) ABSTRACT

A frequency-dependent damper for creating a damping force in response to a variable-frequency disturbance includes an outer damper body having an internal cavity, an inner damper body for receiving the variable-frequency disturbance extending into the internal cavity, a first fluid chamber and a second fluid chamber defined inside the internal cavity, a piston separating the first and second fluid chambers, a selected orifice for transferring fluid between the first and second fluid chambers, and a selected spring element arranged serially between the piston and the inner damper body such that the piston can move relative to the inner damper body through deformation of the spring element.

This application claims the benefit of U.S. Provisional Application No. 61/419,794, filed on Dec. 3, 2010, which is herein incorporated by reference.

### BACKGROUND

Dampers are used on most helicopters with soft in-plane rotors to provide damping to the lead-lag motion of the rotor blades. The lead-lag motion of a rotor blade is the back and forth motion of the blade in a horizontal plane. Significant lead-lag motion of a rotor blade occurs at a lead-lag resonant frequency that is typically less than the rotor operating frequency. The function of the damper is to control this resonance so that the helicopter does not become unstable. The lead-lag damper provides the damping required at the lead-lag resonant frequency while imposing unnecessarily high loads on the hub of the rotor and heating up of the damper at the rotor operating frequency. Thus, a damper that provides the required damping forces at the lead-lag resonant frequency and reduced damping forces at the rotor operating frequency would be an improvement in the technology.

### SUMMARY

In an embodiment, a frequency-dependent damper is provided. The frequency-dependent damper comprises an outer damper body, an inner damper body and a piston. The outer damper body has an internal cavity. A working chamber is defined inside the internal cavity. The piston has an internal chamber defined therein, wherein the piston is movably positioned within the internal cavity. The piston separates the working chamber into a first working chamber and a second working chamber. There is at least one orifice defined on the piston and disposed between an outer piston wall and an inner piston wall. The orifice provides fluid communication between the internal chamber and the first and second working chambers. There is an inner piston plate disposed within the internal chamber of the piston. There is at least one spring element. The spring element is positioned between the inner piston wall and the inner piston plate. An inner damper body is disposed within the outer damper body and coupled to the inner piston plate, wherein the inner damper body is capable of receiving a variable-frequency disturbance communicated to the internal cavity.

In an embodiment, a frequency-dependent damper is provided. The frequency-dependent damper comprises at least one input plate, at least a first damped elastomer and a support member. The first damped elastomer is secured to the input plate. The first damped elastomer has a damping coefficient. The support member is secured to the first damped elastomer such that mechanical energy of a damping force is communicated therebetween, wherein the first damped elastomer is configured to shear in response to relative motion between the input plate and the support member.

In an embodiment of the invention, a frequency-dependent damper for creating a damping force in response to a variable-frequency disturbance comprises an outer damper body having an internal cavity, an inner damper body for receiving the variable-frequency disturbance extending into the internal cavity, a first fluid chamber and a second fluid chamber defined inside the internal cavity, a piston separating the first and second fluid chambers, a selected orifice for transferring fluid between the first and second fluid chambers, and a selected spring element arranged serially between the piston and the inner damper body such that the piston can move relative to the inner damper body through deformation of the selected spring element.

In an embodiment of the invention, a frequency-dependent damper for creating a damping force in response to a variable-frequency disturbance comprises an input member for receiving the variable-frequency disturbance, a support member, a damping structure comprising a first elastomer having a first damping coefficient and a second elastomer having a second damping coefficient, the first and second elastomers being configured to shear in response to relative motion between the input member and the support member, the damping coefficient of the first elastomer being different from the damping coefficient of the second elastomer.

In an embodiment of the invention, a rotary wing system with at least one rotating blade rotating about a rotation axis, the rotary wing system having a variable-frequency disturbance when rotating about the rotation axis, comprises a frequency-dependent damper for controlling the variable-frequency disturbance, the frequency-dependent damper comprising an outer damper body having an internal cavity, an inner damper body for receiving the variable-frequency disturbance extending into the internal cavity, a first fluid chamber and a second fluid chamber defined within the internal cavity, a piston separating the first and second fluid chambers, an orifice for transfer of fluid between the first and second fluid chambers, and a spring element serially arranged between the piston and the inner damper body such that the piston can move relative to the inner damper body through deformation of the spring element.

In an embodiment of the invention, a rotary wing system with at least one rotating blade rotating about a rotation axis, the rotary wing system having a variable-frequency disturbance when rotating about the rotation axis, comprises a frequency-dependent damper for controlling the variable-frequency disturbance, the frequency-dependent damper comprising an input member for receiving the variable-frequency disturbance, a support member, a damping structure comprising a first elastomer and a second elastomer configured to shear in response to relative motion between the input member and the support member, the first elastomer having a first damping coefficient, the second elastomer having a second damping coefficient, the first damping coefficient being different from the second damping coefficient.

In an embodiment of the invention, a method of making a rotary wing damper includes providing an outer damper body having an internal cavity, providing an inner damper body, selecting a piston for providing a first fluid chamber and a second fluid chamber, selecting a spring element, serially arranging the spring element between the piston and the inner damper body such that the piston is movable relative to the inner damper body through a deformation of the selected spring element, and receiving the inner damper body in the outer damper body internal cavity to provide the first fluid chamber and the second fluid chamber defined inside the outer damper body internal cavity, with the piston separating the first and second fluid chambers, with a selected fluid transferring damping orifice between the first and second working chambers, wherein with a relative motion of the inner damper body relative to the outer damper body at a relatively high second frequency (f_{high}) above a selected frequency threshold (f_{threshold}) the selected spring element is substantially deformed and at a relatively low first frequency (f_{low}) below the selected frequency threshold (f_{threshold}) the selected spring element is substantially undeformed.

A method of making a rotary wing damper including providing an input member, providing a support member, providing a damping structure comprising a first elastomer and a second elastomer, the first elastomer having a first damping coefficient, the second elastomer having a second damping coefficient, the first damping coefficient being different from the second damping coefficient, and coupling the damping structure to the input member and support member to allow shearing of the first elastomer and second elastomer in response to relative motion between the input member and the support member.

### BRIEF DESCRIPTION OF DRAWINGS

FIG. 1 is a cross-sectional view of a frequency-dependent damper of the fluid-elastic type.

FIG. 2 is another view of the frequency-dependent damper of FIG. 1.

FIG. 3 is another view of the frequency-dependent damper of FIG. 1.

FIG. 4 is a mechanical model of the frequency-dependent damper of FIG. 1.

FIG. 5 is a graph comparing damping stiffness versus frequency curves for a baseline damper and a frequency-dependent damper.

FIG. 6A is a cross-sectional view of a frequency-dependent damper of the fluid-elastic type.

FIG. 6B is a partial cross-sectional view of a frequency-dependent damper of the fluid-elastic type.

FIG. 7 is a partial cross-sectional view of a frequency-dependent damper of the fluid-elastic type.

FIG. 8 is a partial cross-sectional view of a frequency-dependent damper of the fluid-elastic type.

FIG. 9 is a cross-sectional view of a frequency-dependent damper of the fluid-elastic type.

FIG. 10 is a cross-sectional view of a frequency-dependent damper of the elastic type.

FIG. 11 is a perspective view of an aircraft including a rotary wing system.

FIG. 12 is a perspective view of the rotary wing system of FIG. 11.

### DETAILED DESCRIPTION

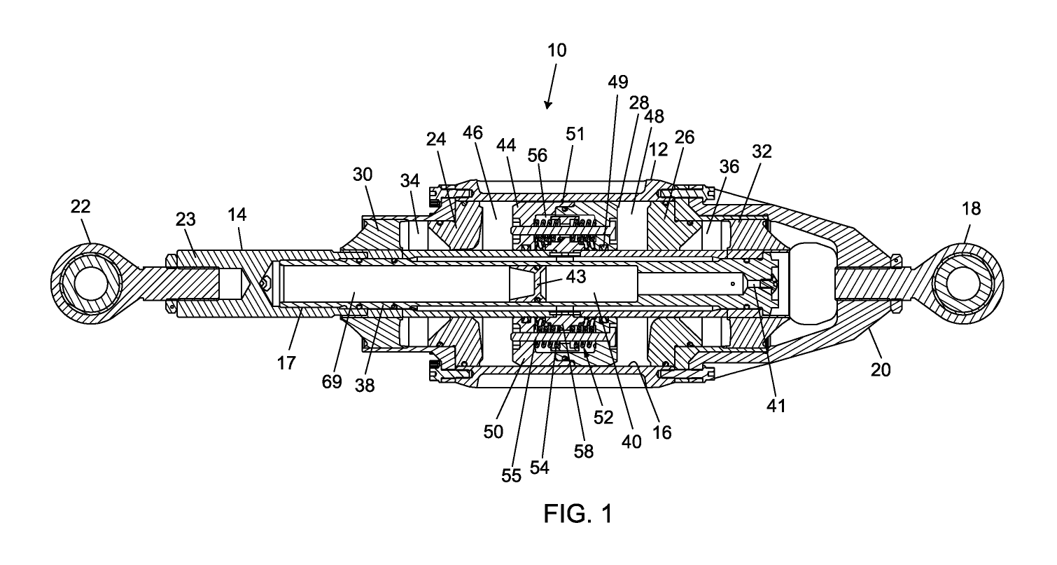

FIG. 1 shows a frequency-dependent damper 10 for creating a damping force in response to a variable-frequency disturbance. The frequency-dependent damper 10 of FIG. 1 is of the fluid-elastic type. In an embodiment, the frequency-dependent damper 10 has an outer damper body 12 and an inner damper body 14. The outer damper body 12 has an outer damper body internal cavity 16. Damping spaces in the outer damper body internal cavity 16 not occupied by solid structures are filled with a damping fluid, an example of which is silicone damping fluid. The inner damper body 14 is having a portion disposed within the outer damper body internal cavity 16. The length of the inner damper body 14 is preferably longer than the length of the outer damper body internal cavity 16 so that a portion of the inner damper body 14 extends outside of the outer damper body internal cavity 16. An outer damper body coupling 18 is mounted at an outer damper body end 20, and an inner damper body coupling 22 is mounted at an inner damper body end 23. The outer and inner damper body couplings 18, 22 can be used to couple the frequency-dependent damper 10 to a system prone to variable-frequency disturbances, such as a rotary wing system of an aircraft, as will be further described below.

Guide bushings 24, 26 are disposed in the outer damper body internal cavity 16, between the outer damper body 12 and the inner damper body 14. In an embodiment, the guide bushings 24, 26 are attached to the outer damper body 12. In an embodiment, the guide bushings 24, 26 are annular. The inner damper body 14 extends through the annuli of the guide bushings 24, 26, and the guide bushings 24, 26 support the inner damper body 14 and guide motion of the inner damper body 14 relative to the outer damper body 12. A working chamber 28 is defined within the outer damper body internal cavity 16 by the guide bushings 24, 26, the outer damper body 12, and the inner damper body 14. Piston 44 is movably positioned in internal cavity 16 of outer damper body 12, thereby being arranged in the working chamber 28. In an embodiment, the working chamber 28 and the piston 44 are annular and concentric. The piston 44 is movable within the working chamber 28 and separates the working chamber 28 into two smaller working chambers 46, 48, each having a variable volume depending on the axial position of the piston 44 within the working chamber 28. Working chambers 46, 48 are also referred to as first working chamber 46 and second working chamber 48. The working chambers 46, 48 are filled with a damping fluid.

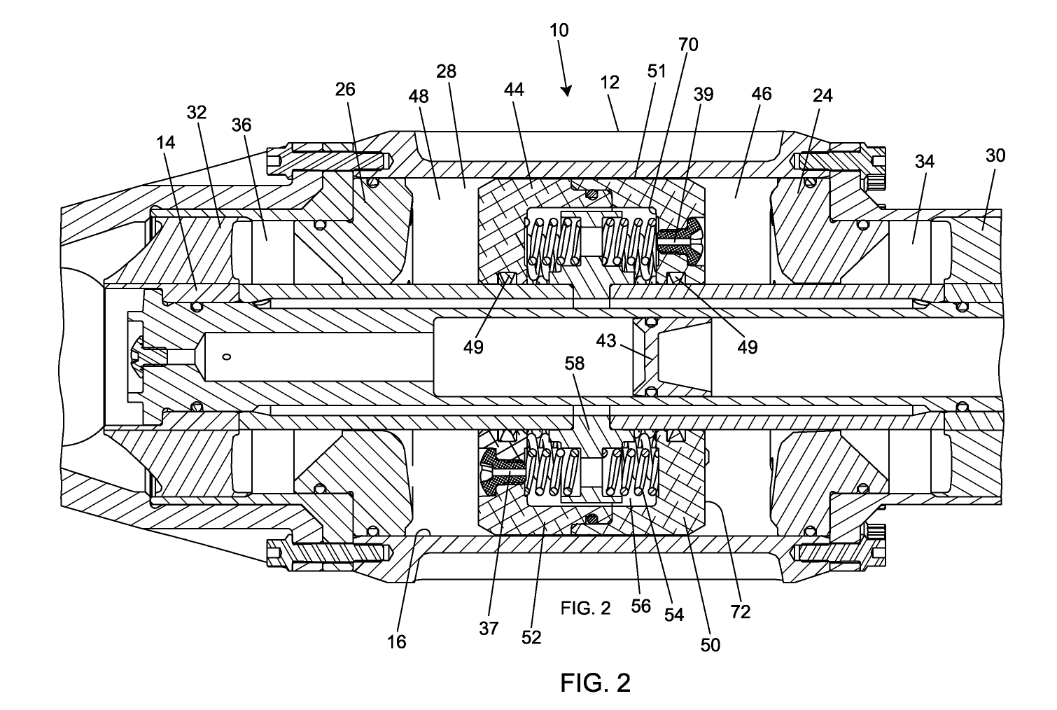

In an embodiment, in FIG. 2, the piston 44 has orifice 37 defined thereon and positioned adjacent to the working chamber 48. Piston 44 also has orifice 39 defined thereon and positioned adjacent to the working chamber 46. The piston 44 has a piston internal chamber 56 defined therein, which is connected to the orifices 37, 39. Thus, the orifices 37, 39 and piston internal chamber 56 define a flow path in the piston 44 for pumping of damping fluid between the working chambers 46, 48. Orifices 37, 39 are disposed between outer piston wall 72 and inner piston wall 70. Orifices 37, 39 provide fluid communication between internal chamber 56 and first working chamber 46 and second working chamber 48. Fluid is pumped between the working chambers 46, 48 in response to the piston 44 traversing the working chamber 28. Damping is related to the amount of fluid pumped through the piston 44. Piston 44 is located between the outer damper body 12 and the inner damper body 14. The piston 44 can move relative to the outer damper body 12. The piston 44 is coupled to the inner damper body 14 and can selectively move relative to the inner damper body 14, as will be further described below. Seals 49 are provided between opposing faces of the piston 44 and the inner damper body 14. Seals 49 may be replaced by slider bearings. A small clearance 51 may be provided between opposing faces of the piston 44 and the outer damper body 12 to provide an alternate flow path between the working chambers 46, 48. The main flow path between the working chambers 46, 48 is preferably through the piston 44, as defined by the orifices 37, 39 and piston internal chamber 56.

In an embodiment, in FIG. 1 or FIG. 2, the frequency-dependent damper 10 includes at least a first elastomeric ring, such as elastomeric rings 30, 32 arranged at or near distal ends of the internal cavity 16 of outer damper body 12. The elastomeric rings 30, 32 engage the outer damper body 12 and the inner damper body 14 and thereby provide seals between the outer damper body 12 and inner damper body 14, preferably non-sliding seals between the outer damper body 12 and inner damper body 14. In an embodiment, the elastomeric rings 30, 32 are attached, bonded, or otherwise fixed, to the outer damper body 12 and the inner damper body 14. Preferably the at least first elastomeric ring is bonded between the outer damper body 12 and the inner damper body 14. Elastomeric ring 30 is adjacent to, but spaced from, the guide bushing 24. By this arrangement, an auxiliary chamber 34 is defined between the elastomeric ring 30, the outer damper body 12, the inner damper body 14, and the guide bushing 24. Also, the elastomeric ring 32 is adjacent to, but spaced from, the guide bushing 26. Also, by this arrangement, an auxiliary chamber 36 is defined between the elastomeric ring 32, the outer damper body 12, the inner damper body 14, and the guide busing 26. In an embodiment, the auxiliary chambers 34, 36 are annular, and the volume of the auxiliary chambers 34, 36 can change when the elastomeric rings 30, 32 are sheared as a result of the inner damper body 14 moving relative to the outer damper body 12. The auxiliary chambers 34, 36 are filled with a damping fluid. Backfill ports(s) and valve(s), not identified separately, may permit fluid flow from the auxiliary chambers 34, 36 to the working chamber 28. In an embodiment, the backfill port(s) and valve(s) do not permit dynamic fluid flow in the direction from the working chamber 28 to the auxiliary chambers 34, 36, thereby allowing the elastomeric rings 30, 32 to be isolated from dynamic pressures in the working chamber 28.

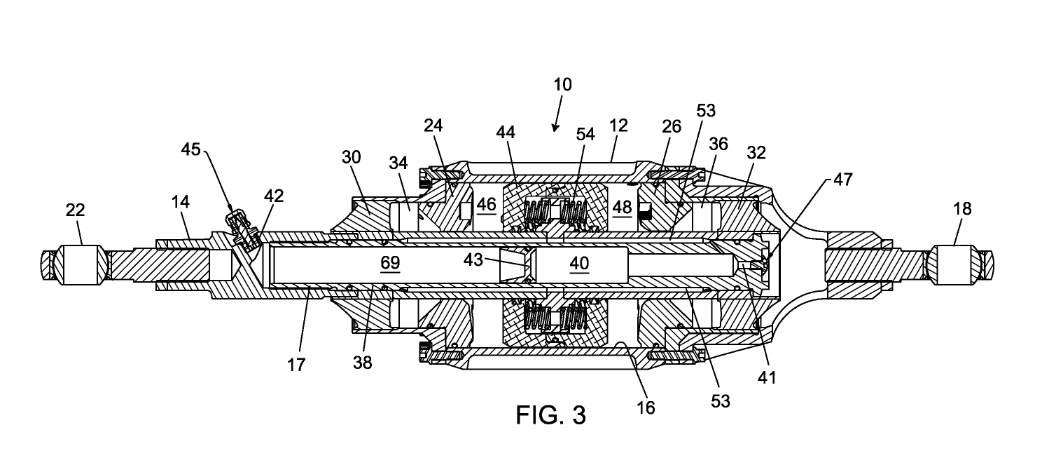

In an embodiment, in FIG. 3, the inner damper body 14 has an inner chamber 17 internally positioned, and inside of which is mounted a volume compensator 38. In an embodiment, the volume compensator 38 includes a gas chamber 69, a fluid chamber 40 and a movable barrier 43 between the chambers 69, 40. The gas chamber 69 can be charged with a suitable gas, such as nitrogen, through a port 42 and charging valve 45. The fluid chamber 40 is connected to the auxiliary chambers 34, 36 and the outer damper body internal cavity 16 via fluid channels 53. Through a port 41 at an end of the volume compensator 38, the fluid chamber 40 and working chambers within the outer damper body internal cavity 16 can be filled with damping fluid. The volume compensator 38 allows for a steady pressure to be applied to the damping fluid within the frequency-dependent damper 10, which prevents cavitation of the fluid. As the frequency-dependent damper 10 heats up and cools down, the damping fluid within the damper will expand and contract. The gas in the gas chamber 69 of the volume compensator 38 is compressible to allow for the expansion and contraction of fluid within the damper.

In an embodiment, in FIG. 1, the frequency-dependent damper 10 includes at least a first spring element 54, arranged serially between the inner damper body 14 and the piston 44. The term “arranged serially” preferably means that the piston 44 can move relative to the inner damper body 14 through deformation of the at least a first spring element 54. The spring element 54 has a spring stiffness and a damping coefficient. When the disturbance applied to the inner damper body 14 is at relatively low first frequencies (f_{low}), the following conditions occur within the damper: (i) the spring element 54 force is substantially higher than the damping force resulting from the working fluid, (ii) the piston 44 is nearly stationary relative to the inner damper body 14, and (iii) the amount of fluid pumped through the piston 44 and resulting damping force are relatively high. As the frequency of the disturbance applied to the inner damper body 14 increases, the damping force of the working fluid increases. Eventually, there will be a point [frequency threshold (f_{threshold})] when the frequency of the disturbance will be high enough that the relative motion between the piston 44 and the outer damper body 12 becomes much less than the motion of the inner damper body 14. Upon crossing the frequency threshold (f_{threshold}) and entering the relatively high second frequencies (f_{high}), the following conditions will occur within the damper: (i) the piston 44 will move substantially relative to the inner damper body 14, and (ii) the amount of fluid pumped through the piston 44 and the resulting damping force will be relatively low (with f_{high} the amount of fluid pumped with the piston 44 is less than with f_{low}, with f_{high} piston 44 motion relative to the inner damper body 14 is greater than with f_{low}).

In an embodiment, the piston 44 is made of two piston plates 50, 52 held together, for example, by means of bolts 55. The orifices (37, 39 in FIG. 2) through which fluid can be pumped between the working chambers 46, 48 are located in the piston plates 50, 52. The size of orifice 37, 39 is selected to reduce damping based upon the anticipated variable frequencies, and the type of fluid having a known density and viscosity. The two unfixed output piston plates 50, 52 define the piston internal chamber 56 of the piston 44 that is connected to the piston orifices (37, 39 in FIG. 2). An inner piston plate 58 is coupled to the inner damper body 14. extending into the piston internal chamber 56. In an embodiment, the spring element 54 is in the form of a metal spring and is disposed in the piston internal chamber 56. The spring element 54 is sandwiched between and makes contact with the unfixed output piston plates 50, 52 and the inner piston plate 58. In combination, the size of orifices 36, 37 and the spring stiffness of spring element 54 are selected to reduce a damping force when a frequency of the variable-frequency disturbance exceeds a selected frequency threshold. In other embodiments, the spring element 54 may take on other forms. For example, elastomer, foam material, or shape memory alloy may be used as the spring element 54.

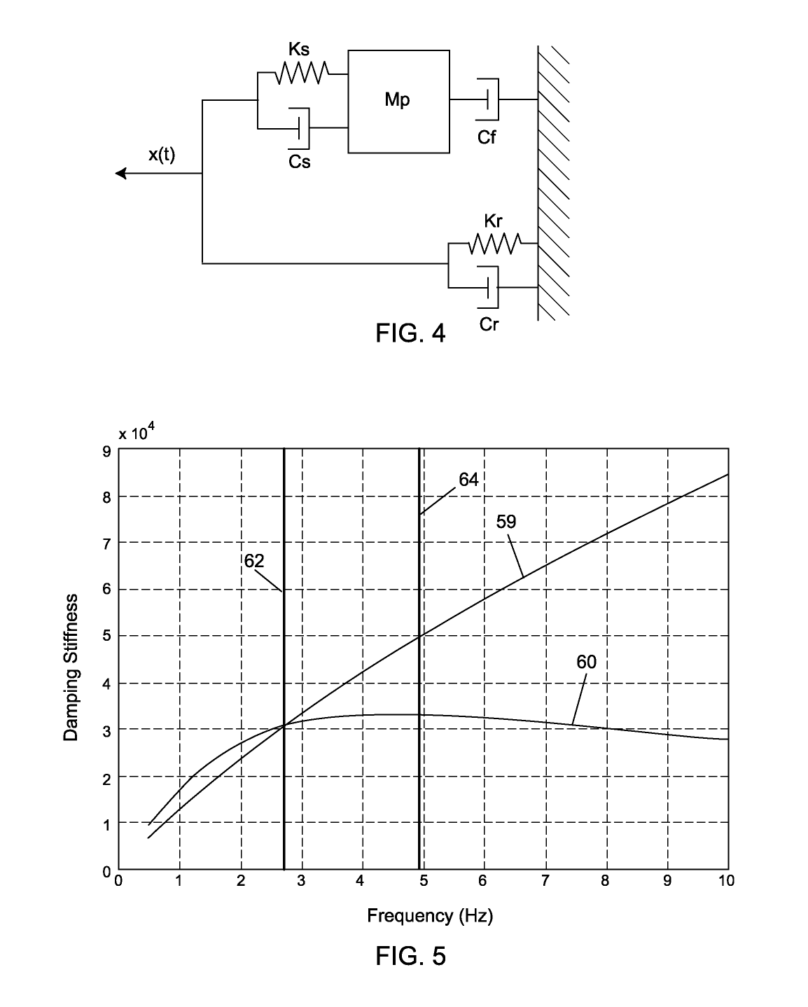

FIG. 4 shows a mechanical model of the frequency-dependent damper 10 of FIG. 1. Ks represents the spring stiffness of the spring element 54, Cs represents damping due to the spring element 54, Mp represents the mass of the piston 44. Cf represents damping due to the working fluid, Kr represents stiffness of the elastomeric rings 30, 32, Cr represents damping due to elastomer rings 30, 32, and x(t) represents displacement or disturbance. In an embodiment, the ratio Ks/Cf is set to a selected frequency threshold. In an embodiment, the frequency-dependent damper 10 provides damping to the lead-lag motion of rotor blades in a rotary wing system, and the selected frequency threshold is between the rotor in-plane natural frequency and the rotor operating frequency. In an embodiment, the selected frequency threshold is greater than 4 Hz. Although, it should be noted that a different frequency threshold may be selected depending on the application.

FIG. 5 is a graph showing damping stiffness (lbs/in) versus frequency (Hz) for a baseline damper and a frequency-dependent damper. The baseline damper does not have a spring element as described for frequency-dependent damper 10 above (or, in other words, the spring element is considered infinitely stiff). The frequency-dependent damper has the characteristics of the frequency-dependent damper 10 described above. The data for the graph was generated with an input displacement (disturbance) of ±0.080 inches (see x(t) in FIG. 4). Curve 59 represents the baseline fluid damper without the spring element. Curve 60 represents the frequency-dependent fluid damper with the spring element. In FIG. 5, curve 59 shows that damping stiffness increases monotonically over the studied range of frequencies for the baseline fluid damper. On the other hand, curve 60 shows that the spring element incorporates second-order dynamics into the frequency-dependent fluid damper such that sufficient damping is created at relatively low first frequencies (f_{low}), and damping does not significantly increase at the relatively high second frequencies (f_{high}). In FIG. 5, line 62 represents a rotor in-plane natural frequency with the selected frequency threshold (f_{threshold}) coinciding with the line 62 rotor in-plane natural frequency, and with the line 64 representing an in-flight rotary wing system rotor operating frequency, with the selected frequency threshold (f_{threshold}) tailored to be below the line 64 rotor operating frequency, with the line 64 rotor operating frequency in the relatively high second frequencies (f_{high}). Compared to the baseline damper, frequency-dependent damper 10, operating in the manner represented by curve 60, has reduced heat generation, lower operating temperature, reduced loads, and increased component reliability.

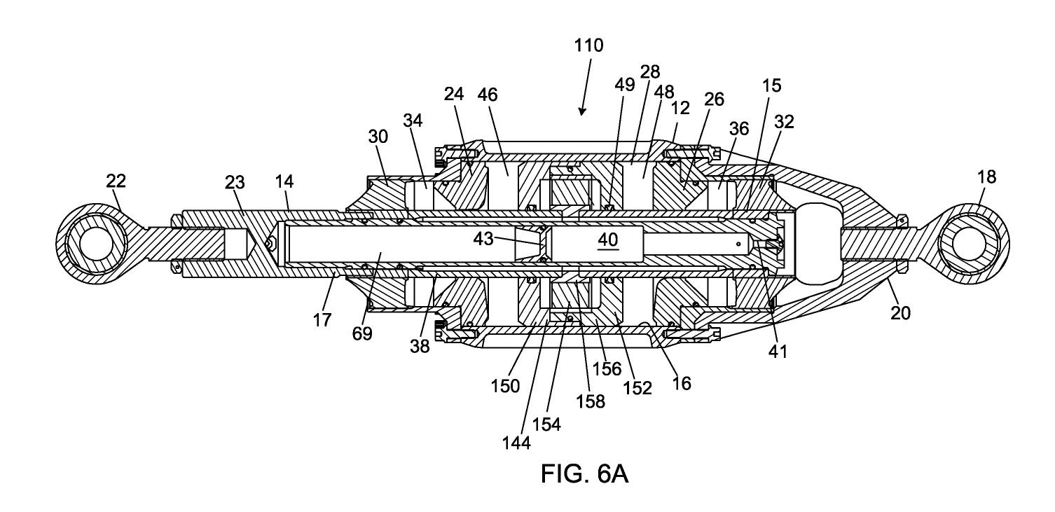

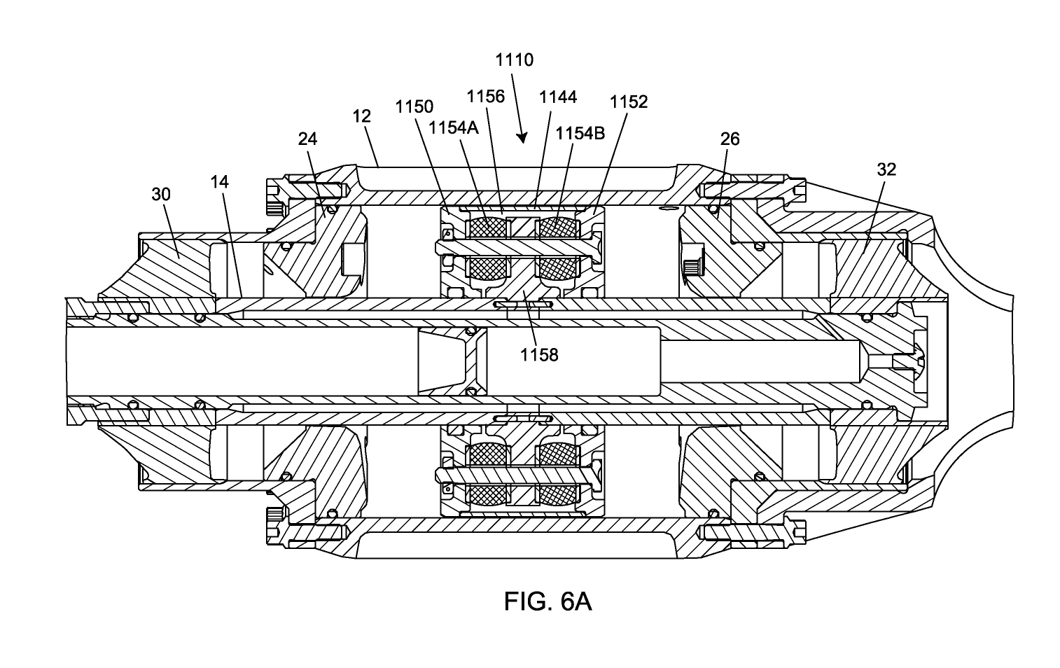

FIG. 6A shows a frequency-dependent damper 110 for creating a damping force in response to a variable-frequency disturbance. The frequency-dependent damper 110 is of the fluid-elastic type. The frequency-dependent damper 110 and the frequency-dependent damper 10 of FIG. 1 are similar, except for the differences described here. Piston 144 has a internal chamber 156 defined by piston plates 150, 152. The inner piston plate 158, which is fixed to the inner damper body 14, which extends into the piston internal chamber 156. The spring element 154 is made of an elastomer and is arranged within the piston internal chamber 156. The elastomeric spring element 154 has an annular shape and circumscribes the inner piston plate 158, which is also annular in shape. The elastomeric spring element 154 is sandwiched between the inner piston plate 158 and the unfixed output piston plates 150, 152 in a radial direction. Disturbance on the inner piston plate 158 is thus transferred to the unfixed output piston plates 150, 152 via the elastomeric spring element 154. The disturbance on the inner piston plate 158 will come from the inner damper body 14 when the inner damper body 14 is coupled to a system subject to the disturbance. As in the case of spring element 54 of FIG. 1, the spring element 154 is arranged serially between the inner damper body 14 and the piston 144 and functions to incorporate second-order dynamics into the damping of the frequency dependent damper 110. Preferably the elastomeric spring element 154 is a shearing elastomeric spring element, with a first surface bonded to a surface of the inner piston plate 158 and a second radially distal surface bonded to a surface of the unfixed output piston plates 150, 152.

FIG. 6B shows a frequency-dependent damper 1110 for creating a damping force in response to a variable-frequency disturbance. The frequency dependent damper 1110 is of the fluid-elastic type. The frequency-dependent damper 1110 and the frequency-dependent damper 110 of FIG. 6A are similar, except for the differences described here. Piston 1144 has an internal chamber 1156 defined by unfixed output piston plates 1150, 1152. The inner piston plate 1158, which is fixed to the inner damper 14, extends into the piston internal chamber 1156. Two spring elements 1154A, 1154B, each made of an elastomer, are arranged within the piston internal chamber 1156, on opposite sides of the inner piston plate 1158. The elastomeric spring elements 1154A, 1154B are annular in shape and circumscribe the inner damper body 14. The elastomeric spring elements 1154A, 1154B are sandwiched between the inner piston plate 1158 and the unfixed output piston plates 1150, 1152. As a result, disturbance on the inner piston plate 1158 can be transferred to the unfixed output piston plates 1150, 1152 via the elastomeric spring elements 1154A, 1154B. As in the case of the spring element 154 of FIG. 6A, the spring elements 1154A, 1154B are arranged serially between the inner damper body 14 and the piston 1144 and function to incorporate second-order dynamics into the damping of the frequency-dependent damper 1110.

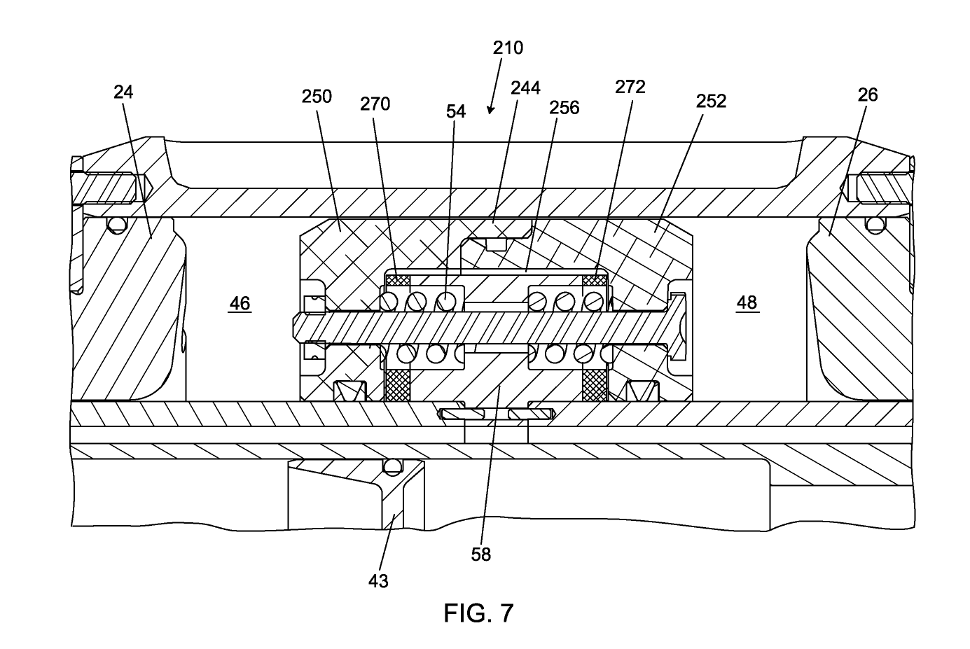

FIG. 7 shows a frequency-dependent damper 210 for creating a damping force in response to a variable-frequency disturbance. The frequency-dependent damper 210 is of the fluid-elastic type. The frequency-dependent damper 210 and the frequency-dependent damper 10 of FIG. 1 are similar, except for the differences described here. In piston 244, elastomeric snubbers or pads 270, 272 are arranged inside the piston internal chamber 256, adjacent to the unfixed output piston plates 250, 252 and distal ends of the spring element 54. The elastomer snubbers or pads 270, 272 limit the axial motion of the spring element 54, which can cause permanent deformation of the spring element 54.

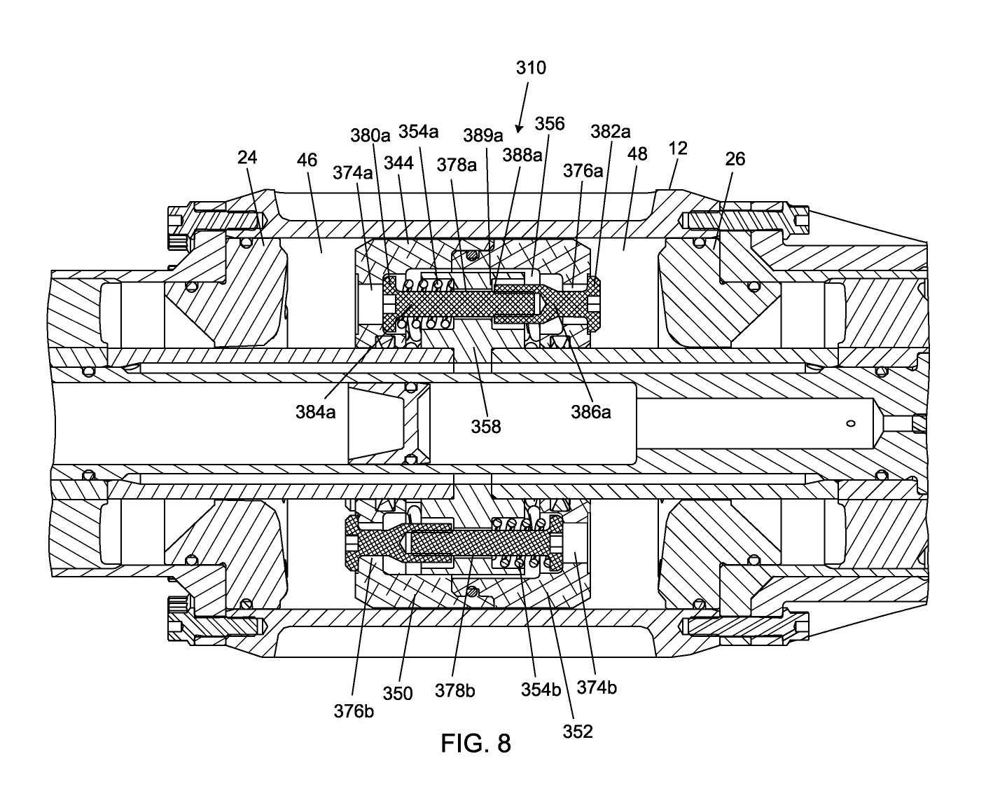

FIG. 8 shows a frequency-dependent damper 310 for creating a damping force in response to a variable-frequency disturbance. The frequency-dependent damper 310 is of the fluid-elastic type. The frequency-dependent damper 310 and the frequency-dependent damper 10 of FIG. 1 are similar, except for the differences described here. Compared to the piston 44 of FIG. 1, the piston 344 of FIG. 8 has an additional flow path for pumping of fluid between the working chambers 46, 48 when there is relative motion between the piston 344 and the inner piston plate 358. The additional flow path, when open under the conditions described above, further reduce the amount of damping generated by the damper.

In the piston 344, an auxiliary orifice 374a is formed in the unfixed output piston plate 350, and an auxiliary orifice 376a is formed in the unfixed output piston plate 352. The auxiliary orifices 374a, 376a are fluidly connected to the piston internal chamber 356. The auxiliary orifices 374a, 376a are in addition to and separate from the orifices normally used for pumping fluid between the working chambers 46, 48. The orifices normally used for pumping fluid are not visible in FIG. 8 because of the particular view of the drawing shown, but they are visible in FIG. 2 as orifices 37, 39. A valve 378a is arranged in the fluid path defined by the auxiliary orifices 374a, 376a and the piston internal chamber 356. The valve 378a has two opposing valve heads 380a, 382a on interlocking stems 384a, 386a, respectively. The valve head 380a is adjacent to the piston plate 350 and orifice 374a, and the valve head 382a is adjacent to the piston plate 352 and orifice 376a.

When the piston 344 is stationary relative to the inner piston plate 358, the valve head 380a abuts the piston plate 350 from the inside of the piston 344 and closes off the orifice 374a. At the same time, the valve head 382a engages the piston plate 352 from the outside of the piston 344 and closes off the orifice 376a. This means that fluid cannot flow between the working chambers 46, 48 through the additional flow path including the orifices 374a, 376a and the piston internal chamber 56. In this position, the spring element 354a bears down on the valve head 380a and thereby keeps the valve heads 380a, 382a in abutting relationship with the piston plates 350, 352, respectively.

When the piston 344 begins to move towards the working chamber 48, the valve head 382a will move with the piston 344, which will result in the valve 378a also moving with the piston 344. Eventually, a shoulder 388a on the valve stem 386a carrying the valve head 382a will contact a shoulder 389a on the inner piston plate 358, resulting in the valve head 382a becoming decoupled from the piston 344. After this, additional motion of the piston 344 towards the working chamber 46 will not move the valve 378a and the orifices 374a, 376a will open up for pumping of fluid between the working chambers 46, 48.

In another portion of the piston 344, an orifice 374b is formed in the piston plate 352, and an orifice 376b is formed in the piston plate 350. A valve 378b is arranged to selectively block the orifices 374b, 376b, as explained above for orifices 374a, 376a and valve 378a. The orifices 374b, 376b are fluidly connected to the piston internal chamber 356, thereby creating an additional flow path for pumping of fluid between the working chambers 46, 48. The mechanism for opening the additional flow path including orifices 374b, 376b is similar to that described for opening the additional flow path including orifices 374a, 376a, with the exception that the additional flow path including orifices 374b, 376b is opened as the piston 344 moves towards the working chamber 46. Thus, with the piston 344, an additional flow path is opened regardless of the travel direction of the piston 344 when the stiffness of the working fluid is greater than the stiffness of the spring element 354a, 354b. The position of the valves 378a, 378b relative to the spring elements 354a, 354b, respectively, also has the effect of limiting the travel of the spring elements 354a, 354b, respectively, and reducing the elastic stiffness of the damper.

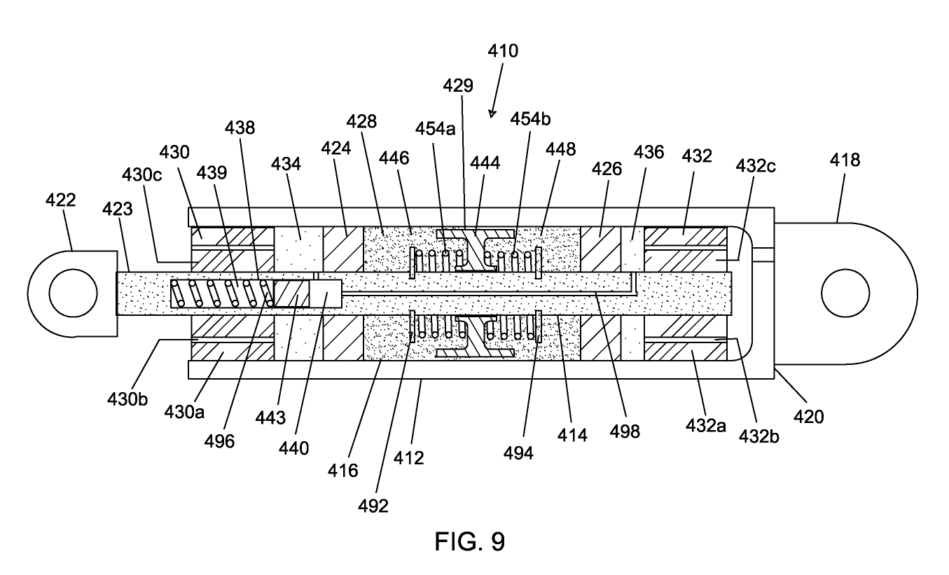

In an embodiment, in FIG. 9, a frequency-dependent fluid damper 410 of the fluid-elastic type is shown. The frequency-dependent fluid damper 410 has an outer damper body 412 and an inner damper body 414. The outer damper body 412 has an outer damper body internal cavity 416 inside of which is received the inner damper body 414. The length of the inner damper body 414 is longer than that of the outer damper body internal cavity 416 so that a portion of the inner damper body 414 extends outside of the outer damper body internal cavity 416. An outer damper body coupling 418 is provided at an outer damper body end 420. An inner damper body coupling 422 is provided at an inner damper body end 423. The outer damper body coupling 418 and inner damper coupling 422 can be used to couple the fluid damper 410 to a system prone to variable-frequency disturbances, such as an aircraft rotary wing system. Guide bushings 424, 426 are disposed in the outer damper body internal cavity 416, i.e., in the annular space between the outer damper body 412 and the inner damper body 414. In an embodiment, the guide bushings 424, 426 are attached to the outer damper body 412 and provide support to the inner damper body 414.

The fluid damper 410 includes a working chamber 428 inside the outer damper body internal cavity 416. The working chamber 428 is located between the guide bushings 424, 426, the outer damper body 412, and the inner damper body 414. A piston 444 is arranged in the working chamber 428. The piston 444 divides the working chamber 428 into smaller working chambers 446 and 448, which are filled with a damping fluid. The piston 444 has or defines one or more orifices for fluid flow between the smaller working chambers 446, 448 as the piston 444 traverses the working chamber 428. In an embodiment, the orifice is an annular orifice 429 formed between the outer diameter of the piston and the inner diameter of the outer damper body 412. In an embodiment, the piston 444 is located between the outer damper body 412 and the inner damper body 414 and can move relative to the outer damper body 412 and inner damper body 414. The piston 444 can move relative to the inner damper body 414 depending on factors that will be further explained below.

Spring elements 454a, 454b are arranged serially between the inner damper body 414 and the piston 444 so that a variable-frequency disturbance on the inner damper body 414 can be transferred to the piston 444 via the spring elements 454a, 454b. In one embodiment, fixed input plates 492 and 494 are fixed to the outer circumference of the inner damper body 414. The input plates 492, 494 are parallel to each other along an axial direction of the inner damper body 414. Spring element 454a is arranged in a gap between the input plate 492 and a side of the piston 444. Spring element 454b is arranged in a gap between the input plate 494 and a side of the piston 444. Spring elements 454a, 454b make contact with the fixed input plates 492, 494, respectively, and the unfixed output piston 444. As in the frequency-dependent dampers described above, spring elements 454a, 454b are arranged serially between the inner damper body 414 and the piston 444 and act to transfer variable-frequency disturbances on the inner damper body 414 to the unfixed output piston 444. The spring elements 454a, 454b each have a stiffness. The ratio of the combined stiffness of the spring elements 454a, 454b to the damping coefficient associated with the working fluid is set to a selected frequency threshold (f_{threshold}). At relatively low first frequencies (f_{low}) substantially below the selected frequency threshold (fₜₕᵣₑₛₕₒₘ), the piston 444 is approximately stationary relative to the inner damper body 414. At the relatively high second frequencies (f_{high}) well above the selected frequency threshold (f_{threshold}), the piston 444 moves relative to the inner damper body 414. Thus, spring elements 454a, 454b work similar to the spring element 54 of FIG. 1 to incorporate second-order dynamics into the frequency-dependent damper 410.

Elastomer rings 430, 432 are provided at the ends of the outer damper body internal cavity 416, in spaced relation to the guide bushings 424, 426. Each of the elastomer rings 430, 432 are preferably a bonded elastomer ring including an annular non-elastomeric shim element 430b (432b), an outer elastomer ring element 430a (432a) bonded to an outer surface of the annular non-elastomeric shim element, and an inner elastomer ring element 430c (432c) bonded to the inner surface of the annular shim element. Auxiliary chamber 434 is defined between the elastomer ring 430 and guide bushing 424, and auxiliary chamber 436 is defined between the elastomer ring 432 and guide bushing 426. The frequency-dependent damper 410 may include back flow port(s) and valve(s) (not shown separately) for fluid communication between the auxiliary chambers 434, 436 and in a direction from the auxiliary chambers into the working chambers 446, 448. A volume compensator 438 is provided inside the inner damper body 414. The volume compensator 438 has chambers 439, 440, and a movable barrier 443 between the chambers 439, 440. A spring 496 is arranged in chamber 439. A fluid conduit 498 connects the chamber 440 to the auxiliary chamber 436. The spring 496 extends or contracts in response to temperature driven changes of the fluid volume of the frequency-dependent damper 410, which results in motion of the movable barrier 443, either to push fluid from the chamber 440 into the fluid conduit 498 or to allow fluid from the fluid conduit 498 into the chamber 440. This preferably provides the appropriate pressure to be applied to the fluid in the damper in order to prevent cavitation of the fluid.

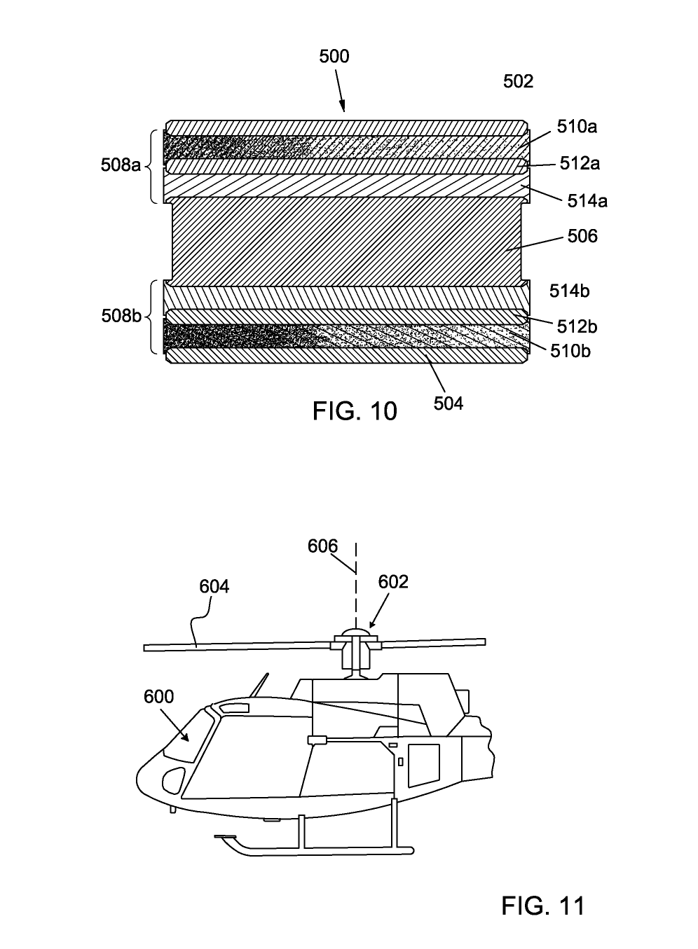

FIG. 10 shows a frequency-dependent damper 500 for creating a damping force, also referred to as a force, in response to a variable-frequency disturbance. The frequency-dependent damper 500 is of the non-fluid elastomeric type. The frequency-dependent damper 500 has parallel and spaced-apart input plates 502, 504. Input plates 502 and 504 are also referred to as input members 502 and 504. A support member 506 is disposed between the input plates 502, 504. A frequency-dependent damping structure 508a is arranged in a gap between the input plate 502 and support 506, and a frequency-dependent damping structure 508b is arranged in a gap between the support 506 and input plate 504. The damping structure 508a is a laminate of a low-damped elastomer 510a having a stiffness and a damping coefficient, a non-elastomeric shim 512a, and a high-damped elastomer 514a having a stiffness and a damping coefficient. The low-damped elastomer 510a is attached to the input plate 502, and the high-damped elastomer 514a is attached to the support member 506. Similarly, the damping structure 508b is a laminate of a low-damped elastomer 510b having a stiffness and a damping coefficient, a non-elastomeric shim 512b, and a high-damped elastomer 514b having a stiffness and a damping coefficient. The low-damped elastomer 510b is attached to the input plate 504, and the high-damped elastomer 514b is attached to the support member 506.

The damping coefficient of the low-damped elastomer 510a is lower than the damping coefficient of the high-damped elastomer 514a, and the damping coefficient of the low-damped elastomer 510b is lower than the damping coefficient of the high-damped elastomer 514b. The damping coefficients of the low-damped elastomers 510a, 510b may be the same or different, and the damping coefficients of the high-damped elastomers 514a, 514b may be the same or different.

In one embodiment, elastomer 510a is referred to as first damped elastomer 510a, elastomer 514a is referred to as second damped elastomer 514a, elastomer 514b is referred to as third damped elastomer 514b, and elastomer 512b is referred to as fourth damped elastomer 512b. Similarly, shim 512a is referred to as first shim 512a and shim 512b is referred to as second shim 512b. Although FIG. 10 illustrates a laminated structure, it is understood that support member 506 and input member 502 and first damped elastomer 510a can form a single structure damping the variable-frequency disturbance. Another configuration uses a single input plate member 502 as a tube about first damped elastomer 510a, first shim 512a, second damped elastomer 514a and support member 506, where support member 506 is positioned internally and input member plate 502 is externally positioned.

The mechanical energy of the force from the variable-frequency disturbance is communicated between the support member, the second damped elastomer, the shim and the first damped elastomer.

In one embodiment the damping coefficient associated with the first damped elastomer 510a is substantially similar to the damping coefficient associated with the fourth damped elastomer 510b, and the damping coefficient associated with the second damped elastomer 514a is substantially similar to the damping coefficient associated with the third damped elastomer 514b. In one embodiment, the damping coefficients associated with the first and fourth damped elastomers 510a, 510b are less than the damping coefficients associated with second and third damped elastomers 514a, 514b. The damping coefficients are selected such that the force of the variable-frequency disturbance is reduced when a frequency of a variable-frequency disturbance exceeds the selected frequency threshold.

The damping coefficients of the elastomers 510a, 510b, 514a, 514b are selected such that the damping force created by the frequency-dependent damper 510 is reduced when the frequency of the disturbance applied to the input plates 502, 504 exceeds a selected frequency threshold (f_{threshold}). The selected frequency threshold (f_{threshold}) may be between the rotor in-plane natural frequency (line 62 in FIG. 5) and the rotor operating frequency (line 64 in FIG. 5) for a rotary wing system application. In a preferred embodiment, the selected frequency threshold (f_{threshold}) is less than the rotor operating frequency (line 64 in FIG. 5). In preferred embodiments the selected frequency threshold (f_{threshold}) is proximate the rotor in-plane natural frequency (line 62 in FIG. 5), preferably with the selected frequency threshold (f_{threshold}) coinciding with rotor in-plane natural frequency (line 62 in FIG. 5). In preferred embodiments the selected frequency threshold (f_{threshold}) is proximate the rotor in-plane natural frequency (line 62 in FIG. 5) and below the rotor operating frequency (line 64 in FIG. 5), preferably with the damper having a damping stiffness that reaches a peak value at a frequency below the in-flight rotor operating frequency (line 64 in FIG. 5).

The elastomeric frequency-dependent damper 500 works similar to the fluid-elastic frequency-dependent dampers described in FIGS. 1-3 and 6A-9. The low-damped elastomers 510a, 510b of the elastomeric frequency-dependent damper 500 function similarly to the spring elements of the fluid-elastic frequency-dependent dampers, and the high-damped elastomers 514a, 514b function similarly to the working fluid of the fluid-elastic frequency-dependent dampers. In the elastomeric frequency-dependent damper 500, shearing of elastomers 510a, 510b, 514a, 514b in response to relative motion between the input plates 502, 504 and support 506, not pumping of fluid, is used to create damping. Preferably the more damping the elastomer has, the less linear its stiffness properties. Therefore, the stiffness of each of the low-damped elastomers 510a, 510b is preferably more linear than that of the corresponding high-damped elastomer 514b, 514b. The selection of the elastomers 510a, 510b, 514a, 514b will depend on the application. Each of the high-damped elastomer 514a, 514b will be selected to ensure the proper level of damping for the application. Based on the selection of the high-damped elastomers 514a, 514b, each of the low-damped elastomers 510a, 510b will be selected to establish the selected frequency threshold.

In use, the input plates 502, 504 are fixed to a system subject to disturbances. Relative motion of the support 506 to the input plates 502, 504 in response to a disturbance applied to the input plates 502, 504 will cause shearing of the elastomers in the damping structures 508a, 508b to provide the damping action. Below a selected frequency threshold (f_{threshold}), the stiffness of the low-damped elastomer 510a is higher than the stiffness of the high-damped elastomer 514a and the stiffness of the low-damped elastomer 510b is higher than the stiffness of the high-damped elastomer 514b, causing the high-damped elastomers 514a, 514b to be sheared, and resulting in high levels of damping. At and above the selected frequency threshold (f_{threshold}), the stiffness of the high-damped elastomer 514a is higher than the stiffness of the low-damped elastomer 510a and the stiffness of the high-damped elastomer 514b is higher than the stiffness of the low-damped elastomer 510b, causing the low-damped elastomers 510a, 510b to be sheared and little to no shearing of the high-damped elastomers 514a, 514b. This has the effect of greatly reducing the amount of damping (with f_{high} the amount of shearing of the high-damped elastomers 514a, 514b is less than with flow).

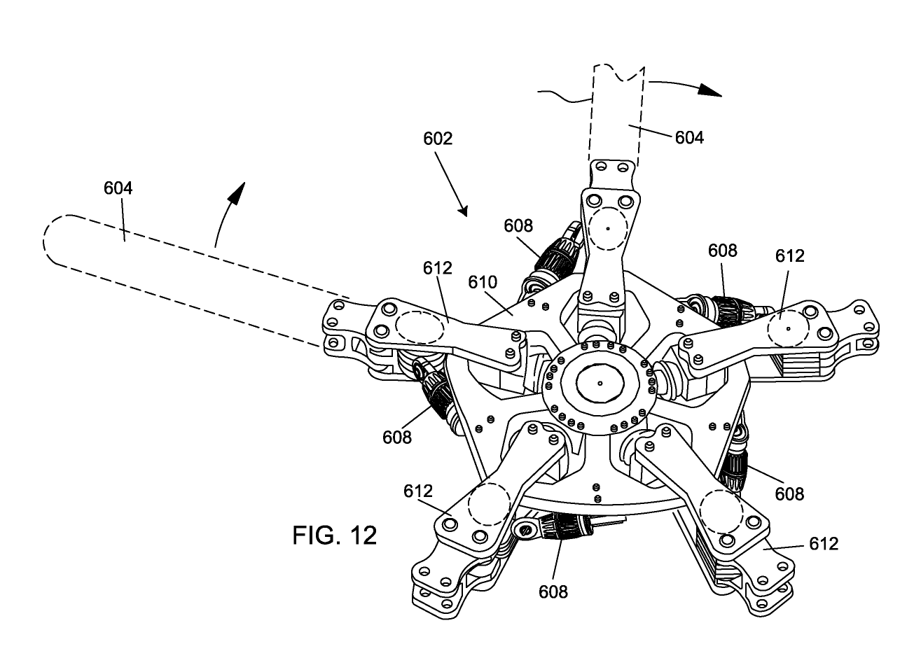

FIG. 11 shows an aircraft 600 having a rotary wing system 602 including at least one rotating blade 604 rotating about a rotation axis 606. The rotary wing system 602 is subject to disturbances when rotating about the rotation axis 606 at least at a rotation operation frequency. FIG. 12 shows a rotary wing system 602 including dampers 608 for controlling the disturbances. The dampers 608 are preferably the frequency-dependent dampers described above. The rotary wing system 602 has a hub 610. Linkages 612 couple blades 604 to the hub 610. One of the ends of each damper 608 is coupled to the hub 610, and the other of the ends of each damper 608 is coupled to the one of the linkages 612. As a result, disturbances during rotation of the blades 604 is transferred to the dampers 608, and the dampers 608 work as described above to damp the disturbances based on the frequency of the disturbances.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

We claim:

1. A frequency-dependent damper comprising:
an outer damper body having an internal cavity;
a working chamber defined inside the internal cavity;
a piston movably positioned within the internal cavity, the piston separating the working chamber into a first working chamber and a second working chamber;
at least one orifice providing fluid communication between the first and second working chambers;
at least one spring element, the spring element positioned between the inner piston wall and the inner piston plate; and
an inner damper body disposed within the outer damper body, wherein the inner damper body is capable of receiving a variable-frequency disturbance communicated to the internal cavity, the inner damper body being coupled to the inner piston plate.

2. The frequency-dependent damper of claim 1, wherein a size of the orifice and a spring stiffness of the spring element are selected to reduce a damping force when a frequency of the variable-frequency disturbance exceeds a selected frequency threshold.

3. The frequency-dependent damper of claim 2, wherein the selected frequency threshold is less than a rotary wing system rotor operating frequency.

4. The frequency-dependent damper of claim 2, wherein the frequency-dependent damper has a damping stiffness having a peak value at a frequency below a rotary wing system rotor operating frequency.

5. The frequency-dependent damper of claim 2, wherein the first chamber and the second chamber contain a damping fluid having a damping coefficient, the spring stiffness, and a ratio of the spring stiffness to the damping coefficient of the damping fluid is set to the selected frequency threshold.

6. The frequency-dependent damper of claim 1, wherein the spring element is a metal spring.

7. The frequency-dependent damper of claim 1, wherein the spring element is an elastomer spring.

8. The frequency-dependent damper of claim 1, further comprising at least one elastomer disposed between the outer damper body and the inner damper body for sealing the internal cavity from at least one end.

9. The frequency-dependent damper of claim 1, wherein the piston is coupled to the inner damper body.

10. The frequency-dependent damper of claim 1, further comprising an inner cavity internally positioned within inner damper body and a volume compensator arranged within the inner cavity.

11. The frequency-dependent damper of claim 10, further comprising a fluid chamber defined within the inner cavity, the fluid chamber being in fluid communication with the volume compensator and in fluid communication with the first and second working chambers.

12. The frequency-dependent damper of claim 1, further comprising a first coupling attached to one end of the outer damper body and a second coupling attached to one end of the inner damper body, wherein the first and second couplings provide mechanical input from a system applying the variable-frequency disturbance to the frequency-dependent damper.

13. A frequency-dependent damper comprising:
at least one input plate;
at least a first damped elastomer secured to the input plate, the first damped elastomer having a damping coefficient;
a support member secured to the first damped elastomer such that mechanical energy of an input force is communicated therebetween, wherein the first damped elastomer is configured to shear in response to relative motion between the input plate and the support member.

14. The frequency-dependent damper of claim 13, further comprising:
at least one shim secured to the first damped elastomer;
at least a second damped elastomer secured to the shim, the second damped elastomer having a damping coefficient and is configured to shear in response to relative motion between the input plate and the support member; and
wherein the support member is secured to the second damped elastomer such that mechanical energy of the input force is communicated between the support member, the second damped elastomer, the shim and the first damped elastomer.

15. The frequency-dependent damper of claim 14, wherein the damping coefficient of the first damped elastomer is lower than the damping coefficient of the second damped.

16. The frequency-dependent damper of claim 14, further comprising:
at least a second input plate;
at least a third damped elastomer having a damping coefficient;
at least a fourth damped elastomer having a damping coefficient;
at least a second shim;
wherein the frequency-dependent damper is laminated, the laminated frequency-dependent damper including:
one input plate having the first damped elastomer secured thereto;
the first damped elastomer secured to the input plate;
one shim secured to the first damped elastomer;
the second damped elastomer secured to the shim;
the support member secured to the second damped elastomer;
the third damped elastomer secured to the support member;
the second shim secured to the third damped elastomer;
the fourth damped elastomer secured to the second shim;
the second input plate secured to the fourth damped elastomer;
wherein the damping coefficient associated with the first damped is substantially similar to the damping coefficient associated with the fourth damped elastomer, and the damping coefficient associated with the second damped elastomer is substantially similar to the damping coefficient associated with the third damped elastomer;
wherein the damping coefficients associated with the first and fourth damped elastomers are less than the damping coefficients associated with second and third damped elastomers; and
wherein the damping coefficients are selected such that the input force is reduced when a frequency of a variable-frequency disturbance exceeds a selected frequency threshold.

17. The frequency-dependent damper of claim 13, wherein the damping coefficient is selected such that the input force is reduced when a frequency of a variable-frequency disturbance exceeds a selected frequency threshold.

18. The frequency-dependent damper of claim 13, wherein the frequency-dependent damper is a laminated structure.

19. The frequency-dependent damper of claim 18, further comprising a second damped elastomer and at least one shim, wherein the shim is interposed between the first and second damped elastomers.

20. The frequency-dependent damper of claim 19, wherein the laminated structure is circular with the support member being centrally positioned.

21. A rotary wing system with at least one rotating blade rotating about a rotation axis, the rotary wing system having a variable-frequency disturbance when rotating about the rotation axis, the rotary wing system comprising:
a frequency-dependent damper for controlling the variable-frequency disturbance, the frequency-dependent damper including:
an outer damper body having an internal cavity;
an inner damper body for receiving the variable-frequency disturbance extending into the internal cavity;
a first fluid chamber and a second fluid chamber defined within the internal cavity;
a piston separating the first and second fluid chambers;
an orifice for transfer of fluid between the first and second fluid chambers; and
a spring element serially arranged between the piston and the inner damper body such that the piston can move relative to the inner damper body through deformation of the spring element.

22. A rotary wing system with at least one rotating blade rotating about a rotation axis, the rotary wing system having a variable-frequency disturbance when rotating about the rotation axis, the rotary wing system comprising:
a frequency-dependent damper for controlling the variable-frequency disturbance, the frequency-dependent damper including:
an input member for receiving the variable-frequency disturbance;
a support member; and
a damping structure having a first elastomer and a second elastomer configured to shear in response to relative motion between the input member and the support member, the first elastomer having a first damping coefficient, the second elastomer having a second damping coefficient, the first damping coefficient being different from the second damping coefficient.

23. A method of making a rotary wing damper, said method including the steps of:
providing an outer damper body having an internal cavity;
providing an inner damper body;
selecting a piston for providing a first fluid chamber and a second fluid chamber;
selecting a spring element;
serially arranging said spring element between the piston and the inner damper body such that the piston is movable relative to the inner damper body through a deformation of the selected spring element, and
receiving said inner damper body in said outer damper body internal cavity to provide the first fluid chamber and the second fluid chamber defined inside the outer damper body internal cavity, with the piston separating the first and second fluid chambers, with a selected fluid transferring damping orifice between the first and second fluid chambers, wherein with a relative motion of said inner damper body relative to said outer damper body at a relatively high second frequency (f_{high}) above a selected frequency threshold (f_{threshold}) said selected spring element is substantially deformed and at a relatively low first frequency (f_{low}) below said selected frequency threshold (f_{threshold}) said selected spring element is substantially undeformed.

24. The method of claim 23 including tailoring a first orifice characteristic of the orifice and tailoring a first spring characteristic of the selected spring element wherein that a damping force is reduced when the relatively high second frequency (f_{high}) exceeds said selected frequency threshold (f_{threshold}).

25. The method of claim 24, wherein the first chamber and the second chamber contain a damping fluid having a damping coefficient, and the first spring characteristic is a spring stiffness, and the ratio of the spring stiffness to the damping coefficient of the damping fluid is set to the selected frequency threshold (f_{threshold}).

26. A method of making a rotary wing damper, said method including the steps of:
providing an input member;
providing a support member; and
providing a damping structure having a first elastomer and a second elastomer, the first elastomer having a first damping coefficient, the second elastomer having a second damping coefficient, the first damping coefficient being different from the second damping coefficient, and coupling the damping structure to the input member and support member to allow shearing of the first elastomer and second elastomer in response to relative motion between the input member and the support member.

27. The method of claim 26, including tailoring the first damping coefficient and the second damping coefficient to reduce a damping force when a frequency of a variable-frequency disturbance applied to the input member exceeds a selected frequency threshold.
